(19) United States
(12) Patent Application Publication
(10) Pub. No.: US 2005/0184834 A1
(43) Pub. Date: Aug. 25, 2005

(54) Methods and apparatus for coupling first and second microwave modules

(76) Inventors: Lewis R. Dove, Monument, CO (US); Robert E. Alman, Santa Rosa, CA (US)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/783,465

(22) Filed: Feb. 20, 2004

(51) Int. Cl. H01P 3/08

(52) U.S. Cl. 333/246

(57) ABSTRACT

In one embodiment, a microwave circuit includes first and second microwave modules, each of which has a conductor sandwiched between upper and lower thickfilm dielectrics, and a ground shield surrounding the dielectrics. At a first end of each conductor, the conductor extends from beneath its upper thickfilm dielectric to terminate at a cut edge of its microwave module. The microwave modules are mounted with their cut edges facing one another. A bridge conductor electrically couples the first ends of the conductors of the microwave modules. A ground shield cap is oriented over the bridge conductor and is electrically coupled to the ground shields surrounding the dielectrics.

### BACKGROUND OF THE INVENTION

In building a microwave circuit, it may be desirable to build a number of microwave modules (i.e., component circuits) and then assemble the microwave modules to form the microwave circuit. A microwave circuit might be formed in this manner if, for example, the microwave circuit is too complex to build on a single substrate. A microwave circuit might also be formed from modules because a manufacturer deems the modules to have independent uses, and it is therefore desirable to sell them individually so that they may be variously coupled and combined.

### SUMMARY OF THE INVENTION

One aspect of the invention is embodied in a microwave circuit comprising first and second microwave modules, each of which has a conductor sandwiched between upper and lower thickfilm dielectrics, and a ground shield surrounding the dielectrics. At a first end of each conductor, the conductor extends from beneath its upper thickfilm dielectric to terminate at a cut edge of its microwave module. The microwave modules are mounted with their cut edges facing one another. A bridge conductor electrically couples the first ends of the conductors of the microwave modules. A ground shield cap is oriented over the bridge conductor and is electrically coupled to the ground shields surrounding the dielectrics.

Other embodiments of the invention are also disclosed.

### BRIEF DESCRIPTION OF THE DRAWINGS

Illustrative and presently preferred embodiments of the invention are illustrated in the drawings, in which:

FIG. 1 illustrates a first exemplary embodiment of a microwave module;

FIG. 2 illustrates a second exemplary embodiment of a microwave module;

FIG. 3 illustrates an exemplary cross-section of two electrically coupled microwave modules;

FIG. 4 illustrates a first exemplary method for coupling first and second microwave modules; and

FIG. 5 illustrates a second exemplary method for coupling first and second microwave modules.

### DESCRIPTION OF THE PREFERRED EMBODIMENT

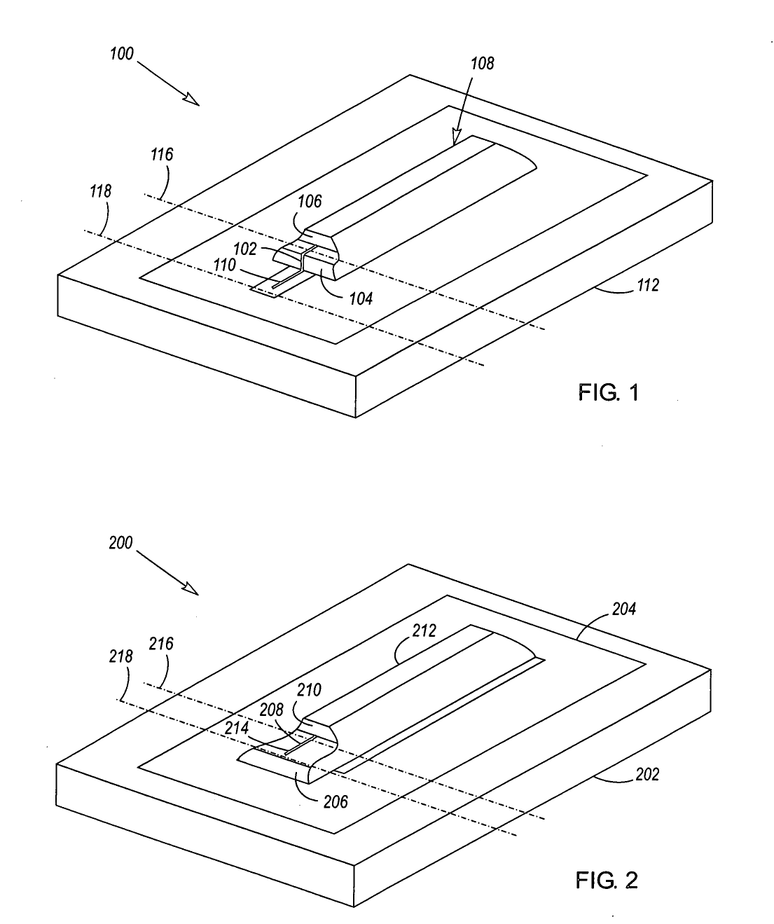

FIG. 1 illustrates a first exemplary microwave module 100. The microwave module 100 comprises a conductor 102 that is sandwiched between upper and lower thickfilm dielectrics 104, 106, and a ground shield 108 that surrounds the dielectrics 104, 106. At a first end 110 of the conductor 102, the conductor extends from beneath its upper thickfilm dielectric 106. As shown, the ground shield 108, dielectrics 104, 106 and conductor 102 may be supported on a substrate 112.

FIG. 2 illustrates a second exemplary microwave module 200. The microwave module 200 comprises a substrate 202 on which a first ground shield 204 is formed. A first dielectric 206 is formed on the first ground shield 204, and a conductor 208 is formed on the first dielectric 206. A second dielectric 210 is formed on the conductor 208, and a second ground shield 212 is formed on the second dielectric 210. As shown, the first and second ground shields 204, 212 may contact one another to provide better shielding for the conductor 208. Also, as shown, at least the second dielectric 210 and second ground shield 212 are recessed from an end 214 of the conductor 208.

By way of example, the substrates 112, 202 of either microwave module 100, 200 may be ceramic, glass, metal, or polymer substrates. Also, by way of example, the dielectrics 104, 106, 206, 210 may be glass dielectrics such as KQ dielectrics, or another dielectric with suitable microwave properties. KQ dielectrics are manufactured by Heraeus Cermalloy (24 Union Hill Road, West Conshohocken, Pa., USA), and one such dielectric is KQ CL-90-7858 dielectric. By way of further example, the conductors 102, 208 may be formed of DuPont QG150 gold (available from DuPont (1007 Market Street, Wilmington, Del., USA)).

Other exemplary microwave modules are disclosed in U.S. Pat. No. 6,255,730 of Dove, et al. entitled “Integrated Low Cost Thick Film RF Module”, and in the United States patent application of Casey, et al. entitled “Methods for Making Microwave Circuits” (Ser. No. 10/600,143 filed Jun. 19, 2003), both of which are hereby incorporated by reference.

In building a microwave circuit, it is sometimes desirable to build a number of microwave modules (i.e., component circuits) such as those shown in FIG. 1 and/or FIG. 2, and then assemble the microwave modules to form the microwave circuit. A microwave circuit might be formed in this manner if, for example, the microwave circuit is too complex to build on a single substrate (such as substrate 112 or 202). A microwave circuit might also be formed from modules because a manufacturer deems the modules to have independent uses, and it is therefore desirable to sell them individually so that they may be variously coupled and combined. Regardless, there are losses associated with joining two different microwave modules. One loss stems from the need to electrically couple the conductors of two different modules with a third, independent conductor. Another loss stems from the absence of shielding where the conductors need to extend from the cover of their dielectrics and ground shields (i.e., to be joined to the conductor of another module). Although it may not be possible to eliminate these losses, methods and apparatus for at least mitigating these losses are proposed herein.

As shown in FIGS. 1 & 2, each of the microwave modules 100, 200 may be cut between a first position (116 or 216) and a second position (118 or 218), thereby creating a cut edge for each module. The first position 116, 216 is chosen to provide a minimum reveal of the end 110, 214 of the conductor 102, 208. As defined herein, a “minimum reveal” is the minimum amount of conductor reveal required for bonding another conductor thereto, as determined by necessary manufacturing variations. The second position 118, 218 is chosen to be at or near the end 110, 214 of the conductor 102, 208 so that the conductor terminates at or near the cut edge. It is preferable, however, that the conductor terminate “at” the cut edge. Although the cuts 116, 216, 118, 218 are shown to be square with existing edges of the microwave modules 100, 200, they need not be. By way of example, the edges may be cut by means of a laser or saw.

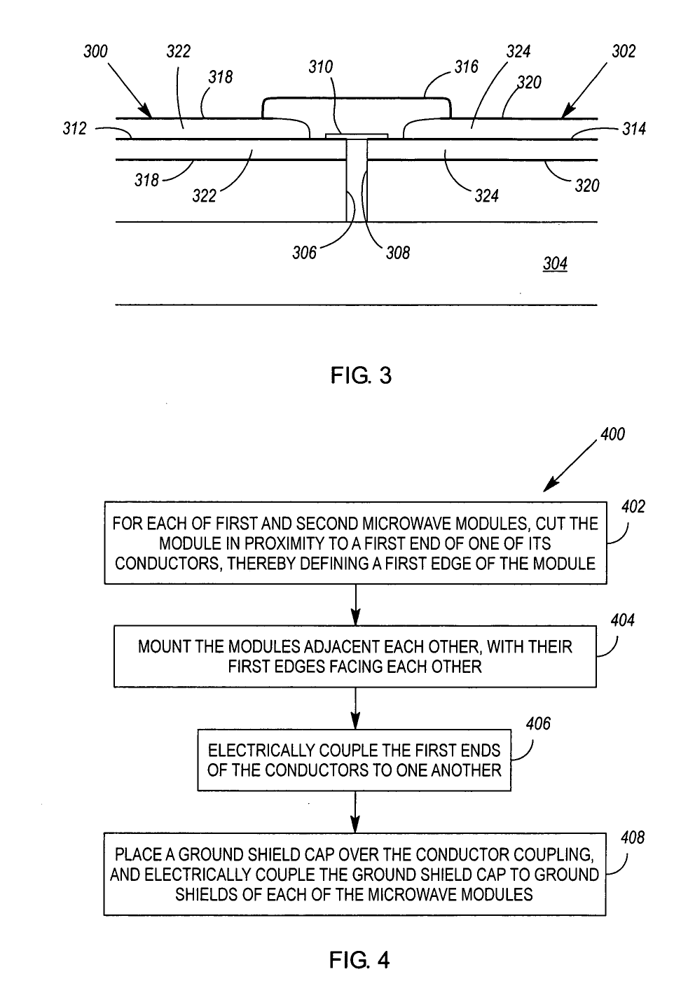

By cutting an edge on a microwave module, it is possible to achieve a conductor termination at or near the edge of the module, thereby minimizing 1) the distance that needs to be bridged when coupling the two conductors to form a larger microwave circuit, and 2) the “reveal” of a shielded conductor. Cutting also provides substantially planar edge surfaces 306, 308 (FIG. 3) that may be positioned facing one another.

If desired, the ends 110, 214 of conductors 102, 208 may be sized wider to provide a greater bonding surface for conductor-to-conductor joining, as will be described in greater detail below.

FIG. 3 illustrates cross-sections of two microwave modules 300, 302 that are positioned adjacent one another (e.g., on a substrate 304). The cut edges 306, 308 of each module face one another. Although the cut edges 306, 308 may touch one another, this need not be the case.

A bridge conductor 310 electrically couples ends of conductors 312, 314 presenting at or near the cut edges 306, 308 of the two modules 300, 302. The bridge conductor 310 should be a low loss conductor and, by way of example, may comprise a ribbon bond, a mesh bond, or a plurality of wire bonds (e.g., a plurality of fine gold wires).

A ground shield cap 316 (e.g., a metallic one), is oriented over the bridge conductor 310. The ground shield cap 316 is then electrically coupled to the ground shields 318, 320 surrounding the dielectrics 322, 324. The ground shield cap 316 may be coupled to the ground shields 318, 320 by solder, conductive epoxy, or some other means. In this manner, at least some shielding is provided for the bridge conductor 310 and exposed portions of conductors 312, 314. Although not shown in FIG. 3, the ground shield cap 316 may extend downward on either side of the bridge conductor 310 and may also be coupled to the ground shields 318, 320 on either side of the bridge conductor 310.

FIG. 4 illustrates a method 400 for cutting and coupling first and second microwave modules (which may be of the types shown in FIG. 1 and/or FIG. 2). The method comprises, for each of the microwave modules, cutting 402 the microwave module in proximity to a first end of one of its conductors, thereby defining a first edge of the microwave module. The microwave modules are then mounted 404 adjacent one another, with their first edges facing each other. Thereafter, the first ends of the conductors are electrically coupled 406 to one another. Finally, a ground shield cap is placed 408 over the conductor coupling, and the ground shield cap is electrically coupled to ground shields of each of the microwave modules.

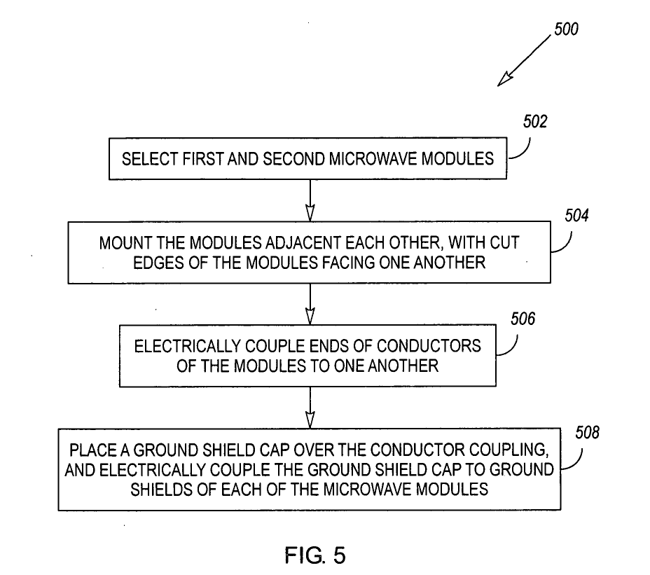

FIG. 5 illustrates a method 500 for assembling a microwave circuit from first and second microwave modules such as those shown in FIG. 1 and/or FIG. 2. First, the microwave modules are selected 502 and mounted 504 adjacent one another, with cut edges of each module facing one another. Ends of the conductors of the microwave modules are then electrically coupled 506 to one another. Finally, a ground shield cap is placed 508 over the conductor coupling, and the ground shield cap is electrically coupled to the ground shields of each of the microwave modules.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A microwave circuit, comprising:
first and second microwave modules, each of which comprises a conductor sandwiched between upper and lower thickfilm dielectrics, and a ground shield surrounding the dielectrics; wherein, at a first end of each of the conductors, the conductor extends from beneath its upper thickfilm dielectric to terminate at a cut edge of its microwave module; the microwave modules being mounted with said cut edges facing one another;
a bridge conductor, electrically coupling the first ends of the conductors; and
a ground shield cap, oriented over the bridge conductor and electrically coupled to the ground shields surrounding the dielectrics.

2. The microwave circuit of claim 1, wherein the bridge conductor comprises a ribbon bond.

3. The microwave circuit of claim 1, wherein the bridge conductor comprises a mesh bond.

4. The microwave circuit of claim 1, wherein the bridge conductor comprises a plurality of wire bonds.

5. The microwave circuit of claim 1, wherein the ground shield cap is electrically coupled to the second ground shields via solder.

6. The microwave circuit of claim 1, wherein the ground shield cap is electrically coupled to the second ground shields via conductive epoxy.

7. The microwave circuit of claim 1, wherein the substrate of each microwave module comprises ceramic.

8. The microwave circuit of claim 1, wherein the first and second dielectrics of each microwave module comprise a KQ dielectric.

9. A microwave circuit, comprising:
first and second microwave modules, each comprising i) a substrate, ii) a first ground shield formed on the substrate, iii) a first dielectric formed on the first ground shield, iv) a conductor formed on the first dielectric, v) a second dielectric formed on the conductor, and vi) a second ground shield formed on the second dielectric; wherein, for each microwave module, at least the second dielectric and second ground shield are recessed from an end of the conductor terminating at or near a cut edge of the microwave module; the microwave modules being mounted with said cut edges facing one another;
a bridge conductor, electrically coupling said ends of the conductors of the microwave modules; and
a ground shield cap, oriented over the bridge conductor and electrically coupled to the second ground shields of the microwave modules.

10. A method for coupling first and second microwave modules, wherein each microwave module comprises i) a substrate, ii) a first ground shield formed on the substrate, iii) a first dielectric formed on the first ground shield, iv) a conductor formed on the first dielectric, v) a second dielectric formed on the conductor, and vi) a second ground shield formed on the second dielectric; and wherein, for each microwave module, at least the second dielectric and second ground shield are recessed from a first end of the conductor; the method comprising:
for each of the microwave modules, cutting the microwave module in proximity to the first end of the conductor, thereby defining a first edge of the microwave module;
mounting the microwave modules adjacent one another, with their first edges facing each other;
electrically coupling said first ends of the conductors of the microwave modules; and
placing a ground shield cap over the conductor coupling, and electrically coupling the ground shield cap to the second ground shields of the microwave modules.

11. The method of claim 10 wherein the conductors are electrically coupled using a ribbon bond.

12. The method of claim 10, wherein the conductors are electrically coupled using a mesh bond.

13. The method of claim 10, wherein the conductors are electrically coupled using a plurality of wire bonds.

14. The method of claim 10, wherein the ground shield cap is electrically coupled to the second ground shields via solder.

15. The method of claim 10, wherein the ground shield cap is electrically coupled to the second ground shields via conductive epoxy.

16. A method, comprising:
selecting first and second microwave modules, each comprising i) a substrate, ii) a first ground shield formed on the substrate, iii) a first dielectric formed on the first ground shield, iv) a conductor formed on the first dielectric, v) a second dielectric formed on the conductor, and vi) a second ground shield formed on the second dielectric; wherein, for each microwave module, at least the second dielectric and second ground shield are recessed from an end of the conductor terminating at or near a cut edge of the microwave module;
mounting the microwave modules adjacent one another, with said cut edge of the first microwave module facing said cut edge of the second microwave module;
electrically coupling said ends of the conductors of the microwave modules; and
placing a ground shield cap over the conductor coupling, and electrically coupling the ground shield cap to the second ground shields of the microwave modules.

17. The method of claim 16, wherein the conductors are electrically coupled using a ribbon bond.

18. The method of claim 16, wherein the conductors are electrically coupled using a mesh bond.

19. The method of claim 16, wherein the conductors are electrically coupled using a plurality of wire bonds.

20. The method of claim 16, wherein the ground shield cap is electrically coupled to the second ground shields via solder.

21. The method of claim 16, wherein the ground shield cap is electrically coupled to the second ground shields via conductive epoxy.
